(19) United States
(12) Patent Application Publication
(10) Pub. No.: US 2004/0156004 A1
(43) Pub. Date: Aug. 12, 2004

(54) Liquid crystal display element and method of forming alignment layer of the liquid crystal element

(75) Inventors: Masanobu Shigeta, Yokosuka-shi (JP); Takashi Moroboshi, Yokohama-shi (JP)

Correspondence Address: CONNOLLY BOVE LODGE & HUTZ LLP, SUITE 800, 1990 M STREET NW, WASHINGTON, DC, 20036-3425, US

(73) Assignee: JVC (VICTOR COMPANY OF JAPAN, LTD.), Yokohama-Shi (JP)

(21) Appl. No.: 10/689,855

(22) Filed: Oct. 22, 2003

(30) Foreign Application Priority Data
Oct. 23, 2002 (JP) 2002-307978

(51) Int. Cl. G02F 1/141

(52) U.S. Cl. 349/134

(57) ABSTRACT

A liquid crystal display element 10 is composed of a pair of boards 11 and 15 that sandwiches liquid crystals 13 having negative dielectric anisotropy, wherein one of the pair of boards 11 and 15 is a transparent board 11, the liquid crystal display element 10 is further composed of inorganic alignment layers 12 and 14 provided on each side of the pair of boards 11 and 15, which faces toward the liquid crystals 13, so as to orientate a pre-tilt angle of the liquid crystals 13 to 3 to 10 degrees.

### BACKGROUND OF THE INVENTION

1. Field of the Invention

The present invention relates to a liquid crystal display element and a method of forming an alignment layer of the liquid crystal display element, particularly, relates to a liquid crystal display device utilized for a display of a video projector having large screen size and a liquid crystal display element utilized for an optical computer, and a method of forming an alignment layer of the liquid crystal display element.

2. Description of the Related Arts

A liquid crystal display element exists as a device, which converts an electrical signal having video information into a video image, or processes (or calculates) optical information without converting the optical information into an electrical signal. By using such a liquid crystal display element, a liquid crystal projector is provided as an apparatus that displays a video image in large screen size.

In such a liquid crystal projector, high resolution and high luminance is particularly essential for performance. A reflective liquid crystal display device that enables both the high resolution and high luminance simultaneously is also provided.

FIG. 12 is a typical cross sectional view of a reflective liquid crystal display device according to the prior art. In FIG. 12, a reference sign 51 is a silicon (Si) substrate. By using a semiconductor processing method, a MOS-FET (Metal Oxide Semiconductor Field Effect Transistor) 52 and a charge storage capacitor 53 is formed on the Si substrate 51. A reference sign 54 is an insulative layer. Reference signs 55, 56 and 57 are a drain terminal, a gate terminal and a source terminal of the MOS-FET 52 respectively.

Further, a reference sign 58 is a reflective electrode layer of aluminum (Al) that is formed on the insulative layer 54. A part of lower section of the reflective electrode layer 58 is connected to the source 57 of the MOS-FET 52. A signal detecting section 59 in plate shape is extended horizontally from the junction part between the reflective electrode layer 58 and the source 57. The charge storage capacitor 53 is constituted by sandwiching a SiO₂ insulative layer 60 between the signal detecting section 59 and the Si substrate 51.

By forming an active element circuit composed of the MOS-FET 52, which is a switching element, and the charge storage capacitor 53 on the Si substrate 51 per each one pixel, consequently, an active element board 61 is constituted totally. A reference sign 71 is a transparent board and constituted by forming a transparent common electrode layer 73 on one surface of a glass substrate 72.

Alignment layers 62 and 74 are formed over surfaces of the reflective electrode layer 58 and a part of the insulative layer 54, which is exposed directly without being covered by the reflective electrode layer 58, in the active element board 61 and a surface of the common electrode layer 73 of the transparent board 71 respectively. A liquid crystal layer 80 having negative dielectric anisotropy is sealed between the alignment layers 62 and 74 of the respective active element board 61 and the transparent board 71. Accordingly, a liquid crystal display (hereinafter referred to as LCD) element is constituted.

Various kinds of driving methods exist to drive a LCD device. It is supposed to be a most suitable driving method for a reflective liquid crystal projector excellent in contrast ratio and response among them that liquid crystals are laid down in parallel to the surfaces of the alignment layers 62 and 74 by using birefringence of the liquid crystals and applying an electric field, wherein an initial orientation state of the liquid crystals is almost perpendicular to the surfaces of the alignment layers 62 and 74. However, by this driving method, liquid crystals are essential to be slanted slightly or given with a pre-tilt angle instead of being perpendicular to the surfaces of alignment layers perfectly. The tilting method of liquid crystals is disclosed in the Japanese Patent No. 2944226.

With respect to a method of forming an alignment layer, both a rubbing method of a polyimide film as an organic layer and an oblique evaporation method of an inorganic layer have been well known.

FIG. 13 is a graph showing a pre-tilt angle of respective polyimide alignment layers according to the prior art. The graph has been issued by Nippon Synthetic Rubber Company and exhibited a pre-tilt angle of polyimide film for vertical orientation. In FIG. 13, material names and pre-tilt angles are indicated on the X-axis and the Y-axis respectively.

In a polyimide alignment layer, a degree of pre-tilt angle is approximately fixed by a combination of a polyimide material and a material of liquid crystal to be used. A pre-tilt angle is hardly changed although filming conditions or rubbing conditions are changed.

Generally, a larger pre-tilt angle is hardly obtained. If a pre-tilt angle could be made larger, a surface condition of film is deteriorated, and resulting in generating unevenness or rubbing lines easily.

As shown in FIG. 13, two groups of polyimide materials exist: the one is a group having a pre-tilt angle of less than 3 degrees and the other is another group having a pre-tilt angle of 9 degrees approximately. Any groups having a pre-tilt angle of 3 to 9 degrees do not exist. Actually, a pre-tilt angle of 3 to 10 degrees could not be obtained without unevenness.

FIG. 14 is a graph showing a relation between an evaporation angle conducted by the conventional oblique evaporation method and a pre-tilt angle according to the prior art. In the case of the conventional evaporation method, no gas is introduced. As shown in FIG. 14, a pre-tilt angle of an inorganic alignment layer is up to 2 degrees approximately. Consequently, in a case of an LCD element composed of an inorganic alignment layer, a pre-tilt angle of more than 3 degrees was not realized.

With respect to a cost of LCD element, it is commonly said that a unit cost is reduced in response to a chip size: the smaller a chip size is, the lower a unit cost becomes. Particularly, in a case of an active matrix type reflective LCD element that is constituted by forming a MOS-FET circuit on a silicon wafer, wherein liquid crystals are driven by the MOS-FET, a cost relation approximately equivalent to a semiconductor process is established.

Accordingly, how a chip size can be made smaller is important for reducing a cost.

On the contrary, in a case that a size of pixel electrode or pixel pitch is the same, a chip size inevitably becomes larger when increasing resolution or a number of pixels.

Consequently, in order to realize higher resolution, it is the first priority to reduce a pixel size.

Further, in a case that resolution is the same, by reducing a pixel size, a chip size becomes smaller and resulting in reducing a cost. In other words, in view of cost, a pixel size is desirable to be smaller as small as possible.

In a case of a liquid crystal projector that projects a video image on a screen by using an LCD device, brightness is one of a most important factor of its performance.

Displaying brightness with respect to a certain screen size is decided totally by an illumination system, an optical system, and a display device.

In a case of a reflective liquid crystal device, several factors deciding brightness of a LCD device exist such as reflectivity of electrode, a numerical aperture (NA), diffraction loss, and driving efficiency of liquid crystal.

Diffraction loss varies by an NA or an F-stop of objective lens. However, the other factors are performance of the reflective liquid crystal device itself.

On the other hand, a device size is extremely important factor although it is not decided by the device alone.

With respect to brightness efficiency of a system, as explained in FIG. 6 of the “IBM J. RES. DEVELOP Vol. 42, No. 3/4 May/July 1998 pp387-399” composed by F. E. Doany et al, for example, it is understood that brightness efficiency is restricted by an NA of optical system, a diagonal length (DSLM) of a display device, and arc gap length of a light source.

Increasing an NA is limited by a contrast ratio and a cost. Generally, an NA is 0.1 to 0.2. An arc gap length of a light source is preferable to be narrower. However, a lamp life is shortened by a narrower arc gap length, so that 1.4 mm to 2 mm of gap length is supposed to be suitable for a practical product level.

In order to maintain a practical efficiency of an LCD element under these conditions, it was found that a DSLM of a display device was essential to be 0.5 inch to 0.7 inch. However, if the DSLM exceeds one inch, the efficiency saturates and resulting in not meriting.

As mentioned above, a certain relationship between a device size and resolution or a number of displaying pixels exists. A pixel size is decided in accordance with designating resolution and a panel size. For example, in the case of displaying in the SXGA resolution (1365 pixels by 1024 pixels) by a device of 0.9 inch, a pixel size or a pixel pitch becomes 13.5 μm.

Further, in the case of displaying a picture of HDTV (1920 pixels by 1080 pixels) program by a device of 0.7 inch, a pixel size becomes 8.1 μm that is extremely smaller than a conventional LCD device having a pixel size of 20 μm.

It was found through examining a LCD device having such a smaller pixel size that such a smaller pixel size generated further problems in characteristics, which did not rise by conventional LCD devices having a regular pixel size.

In the Homeotropic ECB (Electrically Controlled Birefringence) mode, a displaying characteristic of a device varies by a degree of pre-tilt angle extremely.

A smaller pre-tilt angle that is close to perpendicularity makes a contrast ratio larger. However, in the case that a pre-tilt angle is small or close to perpendicularity, a dark line so-called a disclination line easily occurs in adjacent to a border between a white pattern and a black pattern when displaying a black and white pattern having a larger driving voltage ratio.

In the case that such a disclination line occurs, a part of an area of pixel electrodes is not driven, and resulting in decreasing driving efficiency of a pixel. It is not serious problem if brightness merely decreased. However, in a case that change of color occurs, it is a practical problem because of deteriorating color quality.

In a projector that displays full color by synthesizing the three primary colors, for example, black and white lines appear to be colored when displaying the black and white lines in a thin line. In a case of displaying a large block, a certain color may appear on one edge of a pixel.

A mutual relationship between a display element and a system affects such a coloring phenomenon extremely. It is a major cause that a direction of one of devices is inverted on a screen by an optical system of synthesizing three colors.

FIG. 10 is an exemplary drawing showing a frame format of generating a disclination line, and FIG. 11 is an exemplary drawing of disclination line. As shown in FIG. 10, due to a positional relationship between the PBS and the LCD element, an orientation direction of the LCD element, that is, a slanting direction of liquid crystal in the LCD element is rotated clockwise by 45 degrees with respect to the vertical line of rectangular screen of the LCD element and a contrast ratio is increased.

In this occasion, as shown in FIG. 10, a disclination line appears on two edges when only one pixel is driven. In FIG. 11, a disclination line is shown exemplarily when one white line is displayed in a black background.

A dark portion that looks like a line occurs in a certain distance away from an edge of a pixel and is hardly affected by a size of the pixel. Accordingly, the smaller the pixel size becomes, the severer affection with respect to displaying becomes.

As mentioned above, a pixel size is decided by a panel size and resolution of a display device.

Further, a panel size is restricted by system efficiency and a cost of display panel. Consequently, it is commonly supposed that a pixel size having necessary resolution for a projector is preferable to be the order of 7 μm to 15 μm. A pre-tilt angle is essential to be controlled within such a pixel size so as to eliminate affection caused by disclination.

Furthermore, with respect to a method of forming an alignment layer, the rubbing method of polyimide film and the oblique evaporation method of inorganic film is commonly known. However, in the case of a polyimide alignment layer, problems exist such that a pre-tilt angle can hardly be changed and the polyimide alignment layer is easily deteriorated by light.

In the case of the oblique evaporation method, further problems exist such that a pre-tilt angle is merely made up to the order of 2 degrees and can not be extended over 2 degrees, and an inorganic film is poor in repeatability.

### SUMMARY OF THE INVENTION

Accordingly, in consideration of the above-mentioned problems of the prior art, an object of the present invention is to provide a liquid crystal display element having an alignment layer that is optimized in accordance with an object of usage and a method of forming an alignment layer of the liquid crystal display element by improving the problems of the oblique evaporation method of inorganic film particularly.

In order to achieve the above object, the present invention provides, according to an aspect thereof, a liquid crystal display element comprising: a pair of bases of which one base is a transparent base transmitting light; liquid crystals having negative dielectric anisotropy sealed between the pair of bases; and an inorganic alignment layer formed on each surface of the pair of bases facing toward the liquid crystals, the alignment layer orientating a pre-tilt angle of the liquid crystals toward an angle of 3 to 10 degrees.

According to another aspect of the present invention, there provided a method of forming an alignment layer of a liquid crystal display element comprising: a pair of bases of which one base is a transparent base transmitting light; liquid crystals having negative dielectric anisotropy sealed between the pair of bases; and an inorganic alignment layer formed on each surface of the pair of bases facing toward the liquid crystals, the alignment layer orientating a pre-tilt angle of the liquid crystals toward an angle of 3 to 10, degrees, the method is further characterized in that each of the pair of bases is displaced in a filming apparatus such that vapor stream of a material for the inorganic alignment layer displaced in the filming apparatus enters into each of the pair of boards at an angle of 40 to 60 degrees with respect to each normal line of the pair of bases, a gas pressure of either oxygen gas or inert gas introduced into the filming apparatus is controlled so as to conduct the pre-tilt angle to be an angle of 3 to 10 degrees, and that the inorganic alignment layer is formed by being evaporated on each surface of the pair of bases.

Other object and further features of the present invention will be apparent from the following detailed description when read in conjunction with the accompanying drawings.

### BRIEF DESCRIPTION OF THE DRAWINGS

FIG. 1 is a cross sectional view of a liquid crystal display element according to an embodiment one of the present invention.

FIG. 2 is a cross sectional view of a liquid crystal display element showing a frame format of a relationship between a liquid crystal and a pre-tilt angle in a liquid crystal display element shown in FIG. 1.

FIG. 3 is a perspective view of a filming apparatus for forming an alignment layer constituting a liquid crystal display element according to an embodiment two of the present invention.

FIG. 4 is a graph showing a relation between an evaporation angle and a pre-tilt angle of an alignment layer formed on a board, wherein the board formed with the alignment layer is manufactured by a method according to the embodiment two of the present invention.

FIG. 5 is an outline of a conventional measuring system of a contrast ratio.

FIG. 6 is one example of a conventional optical system for evaluating displayed picture quality showing an outline of configuration in blocks.

FIG. 7 is a graph showing a relation between a pre-tilt angel and a contrast ratio according to the present invention.

FIG. 8 is a table showing an evaluation result of a video image in accordance with a pre-tilt angle.

FIG. 9 is a graph showing a result of simulating a driving state of a liquid crystal that is equivalent to intensity with respect to a pre-tilt amount when driving one pixel or one line of a liquid crystal display element having a pixel pitch of 7.6 μm according to the present invention.

FIG. 10 is an explanatory drawing of a disclination line.

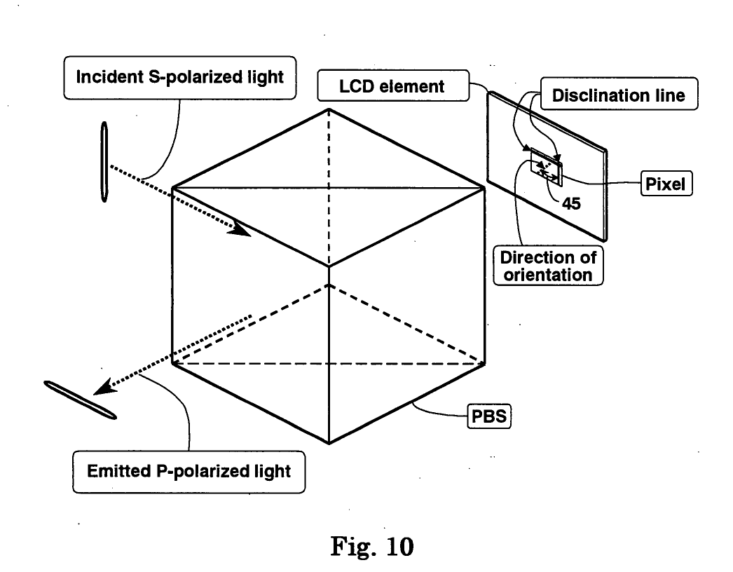

FIG. 11 is an exemplary drawing of a disclination line showing a visible configuration when displaying one white line in a black background.

FIG. 12 is a typical cross sectional view of a reflective liquid crystal display device according to the prior art.

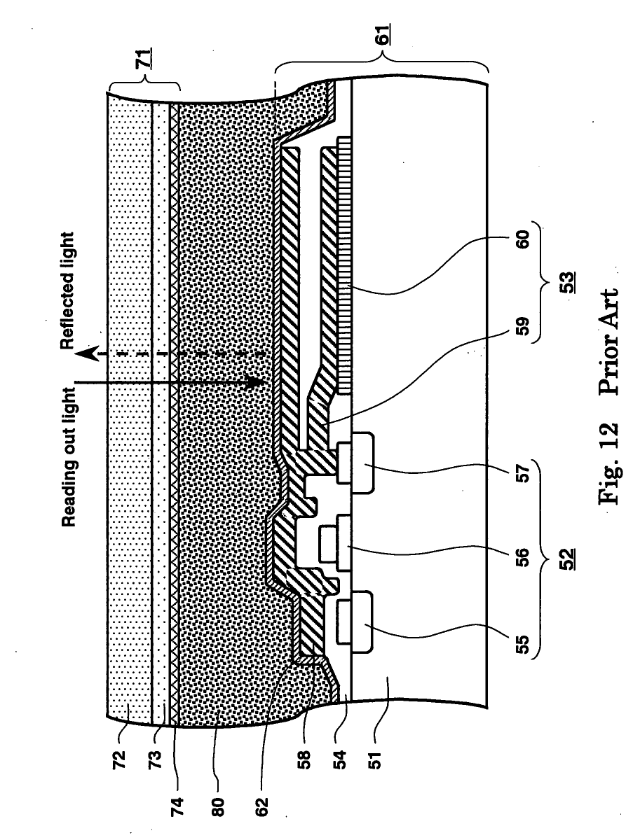

FIG. 13 is a graph showing a pre-tilt angle of a polyimide alignment layer according to the prior art.

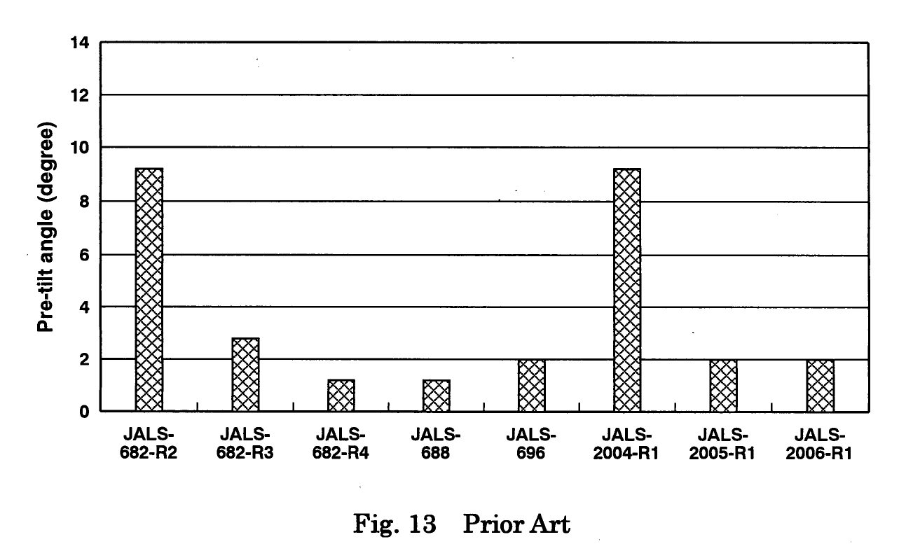

FIG. 14 is a graph showing a relation between an evaporation angle conducted by the conventional oblique evaporation method and a pre-tilt angle according to the prior art.

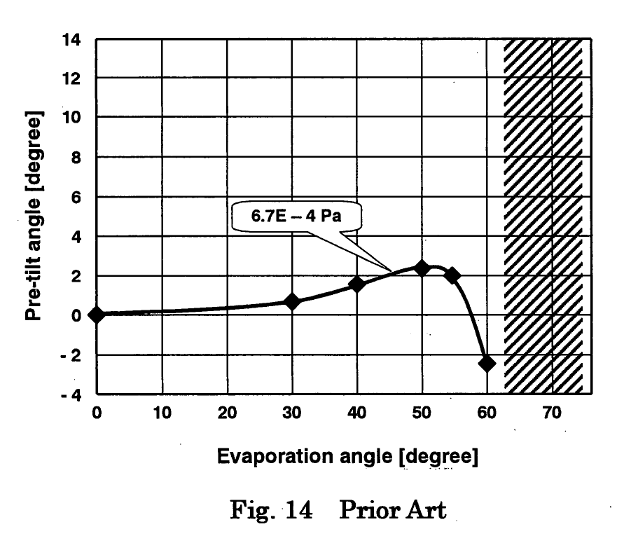

### DETAILED DESCRIPTION OF THE PREFERRED EMBODIMENTS

[Embodiment One]

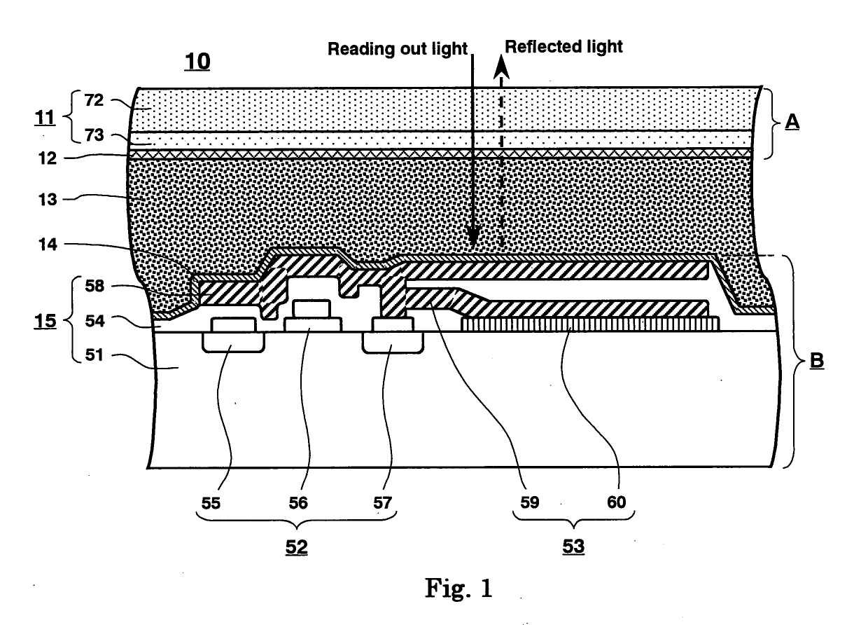

FIG. 1 is a cross sectional view of a liquid crystal display element according to an embodiment one of the present invention.

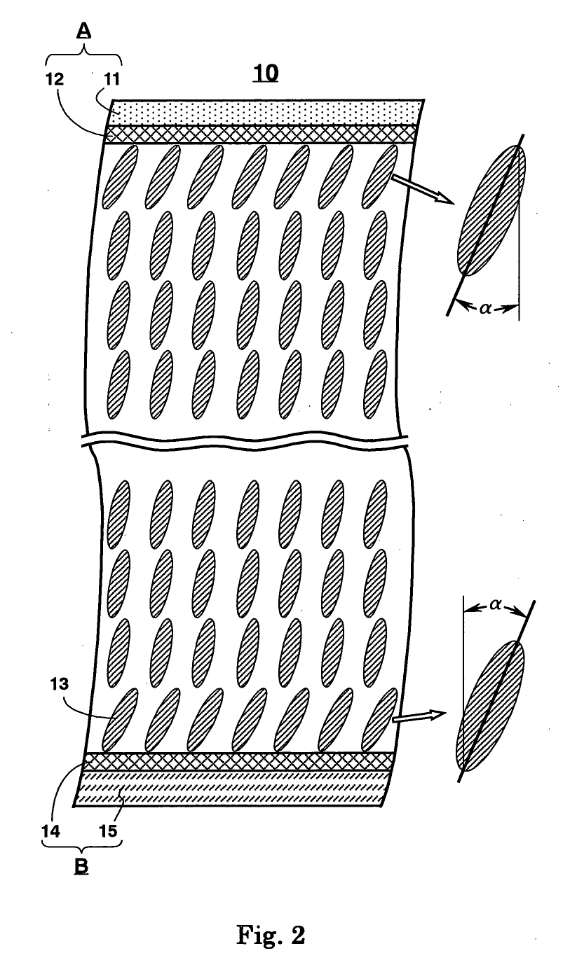

FIG. 2 is a cross sectional view of a liquid crystal display element showing a frame format of a relationship between a liquid crystal and a pre-tilt angle in a liquid crystal display element shown in FIG. 1.

In FIG. 1, a liquid crystal display (hereinafter referred to as LCD) element 10 is composed of a transparent base 11, an inorganic alignment layer 12, a layer of liquid crystals 13, another inorganic alignment layer 14, and a driving base 15. The transparent base 11 is further composed of a glass substrate 72 and a common electrode layer 73. The driving base 15 is further composed of a Si (silicon) substrate 51, an insulative layer 54, and a reflective electrode layer 58.

The LCD element 10 is constituted by sealing the layer of liquid crystals 13 having negative dielectric anisotropy between one pair of bases 11 and 15, that is, the transparent base 11 that transmits light and the driving base 15. In the LCD element 10, inner sides of the bases 11 and 15 facing towards the liquid crystals 13 are provided with the inorganic alignment layer 12 and the other inorganic alignment layer 14. As shown in FIG. 2, each of the liquid crystals 13 is slanted by a pre-tilt angle of α (degree). The LCD element 10 is characterized in that the inorganic alignment layers 12 and 14 orientate the pre-tilt angle α toward an angle of 3 to 10 degrees.

In FIG. 1, a MOS-FET 52 and a charge storage capacitor 53 is formed on the Si substrate 51 through a semiconductor processing method. Reference signs 55, 56, and 57 are drain, gate, and source terminal of the MOS-FET 52 respectively.

Further, the reflective electrode layer 58 is formed on the insulative layer 54. A part of lower section of the reflective electrode layer 58 is connected to the source 57 of the MOS-FET 52. A signal detecting section 59 in plate shape is extended horizontally from the junction part between the reflective electrode layer 58 and the source 57. The charge storage capacitor 53 is constituted by sandwiching a SiO₂ insulative layer 60 between the signal detecting section 59 and the Si substrate 51.

Consequently, by forming an active element circuit composed of the MOS-FET 52, which is a switching element, and the charge storage capacitor 53 on the Si substrate 51 per each one pixel, an active element base 15 is constituted totally. A reference sign “A” is a transparent board composed of the transparent base 11 including the alignment layer 12. The transparent base 11 is constituted by forming the transparent common electrode 73 on one surface of the glass substrate 72. A reference sigh “B” is an active element board composed of the driving base 15 including the alignment layer 14.

The alignment layers 12 and 14 are formed over the surface of the reflective electrode layer 58 and the insulative layer 54 exposed directly in the driving base 15 and the surface of the common electrode layer 73 of the transparent base 11 respectively. The liquid crystals 13 having negative dielectric anisotropy are sealed between the alignment layers 12 and 14 of the respective bases 11 and 15. Then, the LCD element 10 is constituted in total.

Although various kinds of driving methods for a LCD device exist, it is considered as a most suitable driving method excellent in contrast ratio and response for a reflective liquid crystal projector among them that liquid crystals are laid down in parallel to the surfaces of the alignment layers 12 and 14 by using birefringence of liquid crystal and applying an electric field, wherein an initial orientation state of the liquid crystals is almost perpendicular to the surfaces of the alignment layers 12 and 14. The above-mentioned driving method is called a Homeotropic ECB (Electrically Controlled Birefringence) mode or a VAN (Vertically Aligned Nematic) method.

In the case of the Homeotropic ECB mode, liquid crystals are essential to be slanted slightly or given with a pre-tilt angle instead of being perpendicular to the surfaces of alignment layers perfectly, so that controlling a pre-tilt angle is important.

[Embodiment Two]

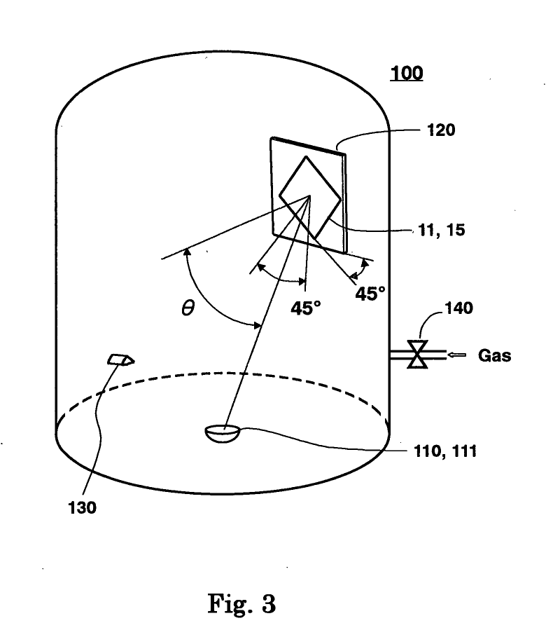

FIG. 3 is a perspective view of a filming apparatus for forming an alignment layer constituting an LCD element according to an embodiment two of the present invention. In FIG. 3, a filming apparatus 100 is composed of an evaporation source 110 filled with an inorganic material 111 for alignment layer, a holder 120 for holding bases 11 and 15, a halogen lamp heater 130, and an intake valve 140 for introducing predetermined gas.

An embodiment two is a method of forming an alignment layer of LCD element that is formed on a base of the LCD element 10. A position of the base 11 or 15 held by the holder 120 in the filming apparatus 100 is adjusted such that vapor stream of the inorganic material 111 disposed in the filming apparatus 100 enters into the base 11 or 15 at an angle θ (hereinafter referred to as evaporation angle θ) of 40 to 60 degrees with respect to the normal line of the base 11 or 15. Oxygen gas is introduced into the filming apparatus 100 through the intake valve 140 and pressure of the oxygen gas is adjusted so as to orientate the pre-tilt angle α toward the angle of 3 to 10 degrees. Then, the inorganic alignment layer 12 or 14 is deposited on the base 11 or 15.

The embodiment two is characterized in that introducing oxygen gas (O₂) forms an inorganic SiO₂ film on a surface of an electrode.

Hereinafter, the method of forming an alignment layer of LCD element that is constituted by a transparent board “A” and an active element board “B” is detailed, wherein the transparent board “A” is constituted by the alignment layer 12 formed on the transparent base 11 composed of the glass substrate 72 and the common electrode layer 73, and the active element board 15 is constituted by the alignment layer 14 formed on the driving base 15 composed of the Si substrate 51 and the insulative layer 54 and the reflective electrode layer 58.

As shown in FIG. 3, the transparent base 11 provided with the transparent common electrode layer 73 and the driving base 15 composed of the Si substrate 51, the insulative layer 54, and the reflective electrode layer 58 of an active matrix type is installed on the holder 120 in the filming apparatus 100. In FIG. 3, the transparent base 11 and the driving base 15 is illustrated in one piece. However, they are actually disposed in an independent position with respect to the evaporation source 110 filled with the inorganic material 111.

An inorganic SiO₂ film having a thickness of 80 nm is deposited on the surface of each electrode layer of the transparent base 11 and the driving base 15 through an evaporation method, and resulting in forming the inorganic alignment layers 12 and 14. Consequently, the transparent board “A” and the active element board “B” is formed.

In the filming apparatus 100, a base temperature is set to 200° C. by the halogen lamp heater 130.

In order to direct a slanting direction of a liquid crystal to the angle of 45 degrees clockwise with respect to the perpendicular line of a screen of a completed LCD element, the base 11 or 15 in rectangular shape is rotated by 45 degrees with respect to the base line of the holder 120 when installing the base 11 or 15 on the holder 120 with adhering in parallel to each other.

As mentioned above, the evaporation angle e between the inorganic material 111 of inorganic SiO₂ filled in the evaporation source 110 and the base 11 or 15 is set such that vapor stream of the inorganic material 111 through the oblique evaporation method enters into the base 11 or 15 at an angle of 40 to 60 degrees with respect to the normal line of the base 11 or 15. However, the evaporation angle e is capable of being set within the range of zero to 70 degrees.

Further, oxygen gas is introduced into the filming apparatus 100 through the intake valve 140 so as to be a predetermined gas pressure while forming the alignment layers 12 and 14. With respect to gas pressure, oxygen gas is introduced into the filming apparatus 100 through the intake valve 140 such that the gas pressure becomes within a range of 6E-3 Pa to 3E-2 Pa, that is, 6×10⁻³ Pa to 3×10⁻² Pa.

A size or pixel pitch of the reflective electrode layer 58 is 7.6 μm and 13.5 μm herein.

The boards “A” and “B”, which are formed with the alignment layer respectively, are adhered by means of a spacer so as to be a predetermined cell thickness and nematic liquid crystals 13 are injected between the boards “A” and “B”. Accordingly, the LCD element 10 is completed (refer to FIG. 1).

By the filming apparatus 100, an alignment layer can be formed on the bases 11 and 15 simultaneously under the same conditions. Therefore, it is a major feature that each pre-tilt angle of the alignment layers formed in the boards “A” and “B” can be designated to be the same pre-tilt angle α.

Manufacturing an LCD element by pairing the boards “A” and “B that are formed with the alignment layers simultaneously is more desirable for enhancing accuracy of the pre-tilt angle α.

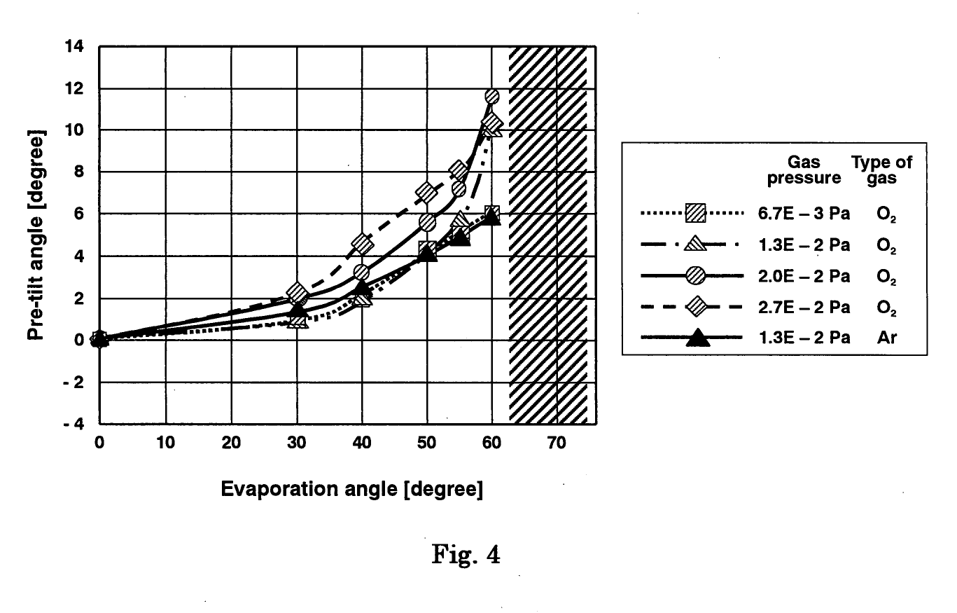

FIG. 4 is a graph showing a relation between an evaporation angle and a pre-tilt angle of an alignment layer formed on a board, wherein the board formed with the alignment layer is manufactured by a method according to the embodiment two of the present invention.

Measuring an evaporation angle and a pre-tilt angle is conducted by manufacturing a sample for measuring (hereinafter the sample for measuring is referred to as a “glass cell” for evaluating pre-tilt). The glass cell is manufactured as follows: preparing a pair of glass substrates formed with an ITO (indium tin oxide) film, wherein the glass substrate is the same shape as an LCD element, forming an alignment layer on the ITO film at the same time forming an alignment layer on a base of the LCD element, and manufacturing a glass cell by adhering one pair of glass substrates formed with the alignment layer respectively. A crystal rotation method is adopted for measuring a pre-tilt angle of the glass cell.

As shown in FIG. 4, a curve plotted by a doted line with square marks in which oxygen gas (O₂) pressure is 6.7E-3 Pa exhibits that a pre-tilt angle increases in accordance with increasing evaporation angle. The pre-tilt angle shows 4.5 degrees at the evaporation angle of 50 degrees and 6 degrees at the evaporation angle of 60 degrees. Consequently, by adjusting an evaporation angle, a predetermined pre-tilt angle exceeding 3 degrees that is never realized by the conventional method can be obtained.

in a case that oxygen gas (O₂) pressure is increased up to 1.3E-2 Pa, which is exhibited by a chain line with hatched triangle marks in FIG. 4, a pre-tilt angle increases in accordance with increasing evaporation angle. The pre-tilt angle shows 4.5 degrees at the evaporation angle of 50 degrees, and the pre-tilt angle rapidly increases at the evaporation angle of 50 to 60 degrees and shows 10 degrees at the evaporation angle of 60 degrees.

In a case that oxygen gas (O₂) pressure is further increased up to 2.0E-2 Pa, which is exhibited by a solid line with circle marks in FIG. 4, a pre-tilt angle increases in accordance with increasing evaporation angle. The pre-tilt angle shows 5.5 degrees at the evaporation angle of 50 degrees. The pre-tilt angle rapidly increases at the evaporation angle of 50 to 60 degrees and shows 11.5 degrees at the evaporation angle of 60 degrees.

Further, in a case that oxygen gas pressure is 2.7E-2 Pa, which is exhibited by a curve plotted by a broken line with lozenge marks in FIG. 4, a pre-tilt angle increases in accordance with increasing evaporation angle. The pre-tilt angle shows 7 degrees at the evaporation angle of 50 degrees and 10 degrees at the evaporation angle of 60 degrees.

In a case of introducing oxygen gas, a pre-tilt angle increases in accordance with increasing evaporation angle, so that a pre-tilt angle at a certain evaporation angle can be made larger than a pre-tilt angle without introducing oxygen gas. Accordingly, it is apparent that a predetermined pre-tilt angle exceeding 3 degrees that is never realized by the conventional method can be obtained by adjusting an evaporation angle.

In order to maintain a pre-tilt angle of 3 to 10 degrees, it is apparent from FIG. 4 that an evaporation angle shall be set to 40 to 60 degrees and oxygen gas pressure shall be set to 6E-3 Pa to 3E-2 Pa.

In a case that an evaporation angle exceeds 60 degrees, scattering and irregularity occurs drastically.

In a case that inert gas such as argon gas (Ar) is introduced at a gas pressure of 1.3E-2 Pa, a relation between an evaporation angle and a pre-tilt angle is exhibited by a solid line with black triangle marks in FIG. 4. As shown in FIG. 4, a trend of introducing argon (Ar) gas is similar to that of introducing oxygen gas: a pre-tilt angle increases in accordance with increasing evaporation angle. The pre-tilt angle is 4 degrees at the evaporation angle of 60 degrees and 6 degrees at the evaporation angle of 60 degrees.

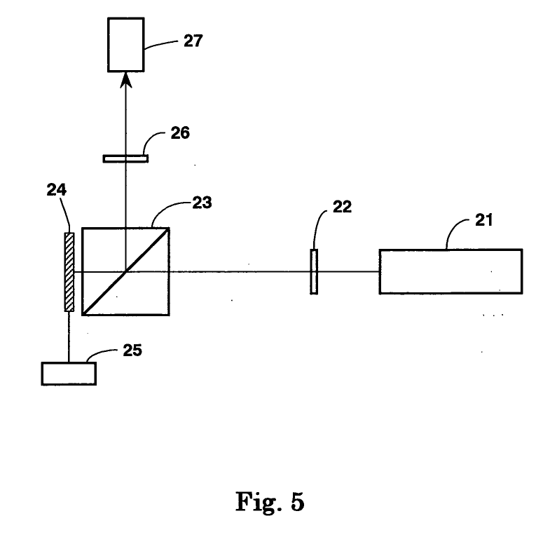

FIG. 5 is an outline of a conventional measuring system of a contrast ratio.

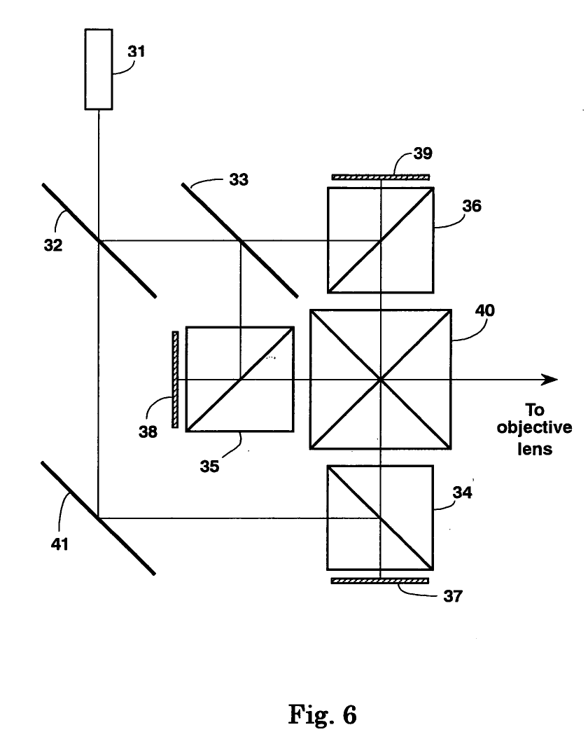

FIG. 6 is an outline of a conventional optical system for evaluating quality of a displayed picture.

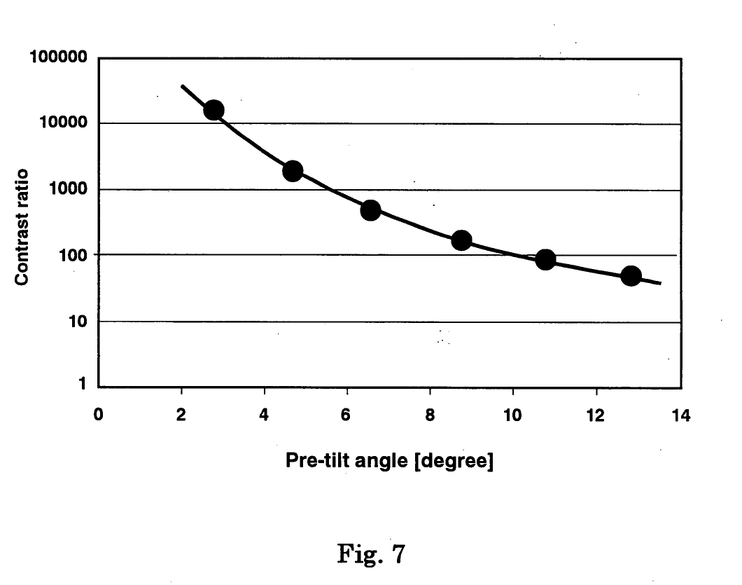

FIG. 7 is a graph showing a relation between a pre-tilt angel and a contrast ratio according to the present invention.

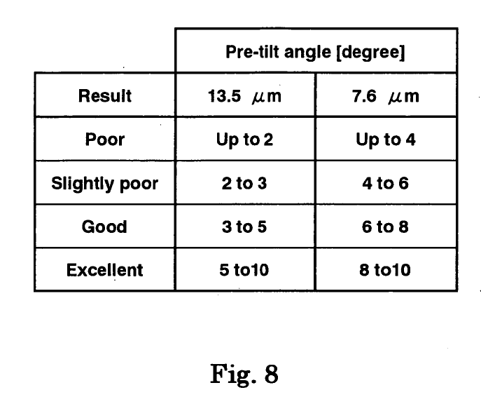

FIG. 8 is a table showing an evaluation result of a pre-tilt angle and a picture.

A contrast ratio of these glass cells manufactured as mentioned above is measured by the measuring system shown in FIG. 5 and an occurring amount of disclination line is measured by the optical system shown in FIG. 6. In FIG. 5, the measuring system is composed of a laser beam source 21, a first polarizing plate 22, a beam splitter 23, an LCD element 24 to be measured as a glass cell, a driving circuit 25, a second polarizing plate 26, and a light power meter 27. In FIG. 6, the optical system is composed of a light source 31, a first dichroic mirror 32, a second dichroic mirror 33, a polarizing beam splitter 34 for red light (hereinafter referred to as PBS-R 34), a polarizing beam splitter 35 for green light (hereinafter referred to as PBS-G 35), a polarizing beam splitter 36 for blue light (hereinafter referred to as PBS-B 36), a first LCD element 37, a second LCD element 38, a third LCD element 39, a cross dichroic prism 40, and a mirror 41.

With referring to FIGS. 5-8, results of measurement are detailed next.

As shown in FIG. 5, a He-Ne laser beam having a wavelength of 544 nm is emitted by the laser beam source 21 and irradiated on the glass cell 24 to be measured through the first polarizing plate 22. The He-Ne laser beam is modulated and reflected by the LCD element 24. The reflected He-Ne laser beam is separated by the beam splitter 23 and enters the light power meter 27 through the second polarizing plate 26, wherein a cell thickness of the LCD element 24 is 3.2 μm.

A contrast ratio of the LCD element 24 is measured as follows: an input signal is changed from zero to a maximum level by the driving circuit 25 and intensity of light is measured by the light power meter 27 while changing the level of an input signal.

The graph shown in FIG. 7 shows a trend such that a contrast ratio decreases in accordance with increasing pre-tilt angle. In a case that a pre-tilt angle is 3 degrees, for example, a contrast ratio is approximately 10000:1. In a case of 6 degrees, a contrast ratio is approximately 1000:1. In a case that a pre-tilt angle exceeds 10 degrees, a contrast ratio becomes less than 100:1 and the contrast ratio is not suitable for a device to display a video image.

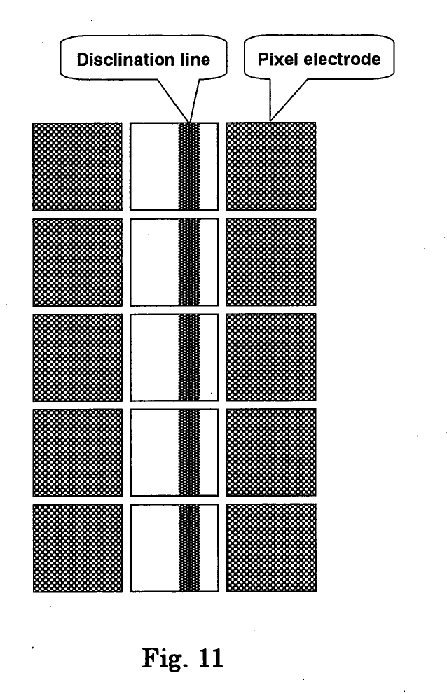

In a case of driving one column of pixels, a dark line, that is, a disclination line shown in FIG. 11 is observed.

A location of the disclination line from an edge and intensity of the disclination line varies by a cell thickness and a wavelength of measuring light. However, it is almost independent of a pixel size.

On the other hand, a location of the disclination line from an edge and intensity of the disclination line changes in response to a pre-tilt angle.

Data shown in FIG. 8 are a result of evaluating a picture visually with respect to picture quality or a degree of coloring when displaying a white line on a screen in various angles by using the optical system shown in FIG. 6. The table shown in FIG. 8 exhibits a pre-tilt angle in degree with respect to two display devices having a pixel pitch of 13.5 μm and 7.6 μm respectively.

As shown in FIG. 6, light emitted form the light source 31 is separated into three primary colors of RGB (red-green-blue) by the first and second dichroic mirrors 32 and 33 and enters the first to third LCD elements 37, 38 and 39 through the PBS-R 34, PBS-G 35 and PBS-B 36 respectively. Each light of RGB colors is modulated and reflected by each of the LCD elements 37, 38 and 39 respectively. The reflected each light is synthesized by the cross dichroic prism 40 and projected on a screen in magnified scale through an objective lens not shown.

Further, a λ/4 plate not shown is inserted between each display device and PBS (polarizing beam splitter) so as to improve a contrast ratio.

The optical system shown in FIG. 6 is such an optical system that is utilized in a projector normally. Constitution-wise, an image direction of the LCD element 38 displayed on a screen actually is inverted in right and left or upside down with respect to image directions of the LCD elements 37 and 39 displayed on the screen, so that a location of disclination line on a pixel is also inverted in right and left or upside down. Consequently, coloring is enhanced in accordance with an amount of disclination.

As shown in FIG. 8, in a case of the LCD element having a pixel pitch of 13.5 μm, coloring of a line is clearly observed at a pre-tilt angle of less than one degree according to the result of video image evaluation. The coloring of a line is improved at a pre-tilt angle of 2 to 3 degrees and reduced to a level that does not matter in practical application at a pre-tilt angle of more than 3 degrees.

Further, in a case of the LCD element having a pixel pitch of 7.6 μm, coloring of a line is reduced to a level that does not matter in practical application at a pre-tilt angle of more than 6 degrees.

A disclination line moves to an edge of a pixel and intensity reduces in accordance with increasing pre-tilt angle.

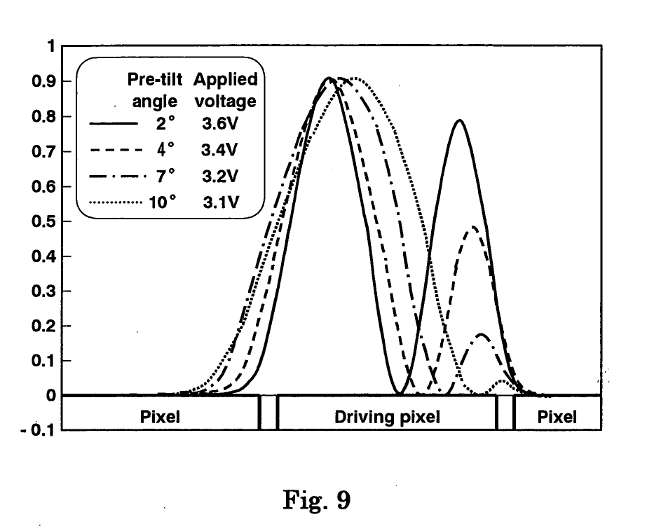

FIG. 9 is a graph showing a result of simulating a driving state of a liquid crystal (that corresponds to intensity) with respect to a pre-tilt amount when driving one pixel or one line of an LCD element having a pixel pitch of 7.6 μm according to the present invention. In FIG. 9, a thickness of a liquid crystal and a gap between pixels is 3.2 μm and 0.5 μm respectively. A voltage that makes intensity maximum is applied to a driving pixel with respect to each pre-tilt angle and 1 V (one volt) is applied to the other pixels as a threshold voltage. In FIG. 9, a recessed well between a main peak and a sub peak is observed as a disclination line. It is apparent from FIG. 9 that a recessed well moves to an edge of the driving pixel and a sub peak reduces drastically in accordance with increasing pre-tilt angle. In a case that a pixel size becomes smaller such as 7.6 m, it is predicted that a disclination line is hardly observed at a pre-tilt angle of the order of 7 degrees although a magnifying power is essential to be increased.

Further, as shown in FIG. 9, the sub peak at the pre-tilt angle of 10 degrees is almost disappeared. Consequently, it is predicted that increasing a pre-tilt angle to more than 10 degrees is almost meaningless in consideration of deteriorating contrast ratio.

[Embodiment Three]

An embodiment three relates to forming an inorganic Al₂O₃ film on a surface of electrode of the bases 11 and 15 as an alignment layer by introducing oxygen gas (O₂).

A method of forming an alignment layer is similar to that of the embodiment two. The transparent base 11 provided with the transparent common electrode layer 73, and the driving base 15 composed of the Si substrate 51, the insulative layer 54, and the active matrix type reflective electrode layer 58 is installed on the holder 120 in the filming apparatus 100 shown in FIG. 3. An inorganic Al₂O₃ film having a thickness of 80 nm is deposited on the surface of each electrode layer of the transparent base 11 and the driving base 15 through an evaporation method, and resulting in forming the inorganic alignment layers 12 and 14. Consequently, the transparent board “A” and the active element board “B” is formed.

In the filming apparatus 100, a board temperature is set to 200° C. by the halogen lamp heater 130.

An evaporation angle θ between the inorganic material 111 for inorganic Al₂O₃ provided in the evaporation source 110 and the base 11 or 15 is set such that vapor stream of the inorganic Al₂O₃ through the oblique evaporation method enters into the base 11 or 15 at a predetermined angle with respect to the normal line of the base 11 or 15. The evaporation angle θ is set to 55 degrees hereupon.

Further, oxygen gas (O₂) is introduced into the filming apparatus 100 so as to be a gas pressure of 1.3E-2 Pa through the intake valve 140 while forming the alignment layers 12 and 14. Furthermore, a size or a pixel pitch of the reflective electrode layer 58 is 13.5 μm herein.

After forming the alignment layers 12 and 14, octadecanol is evaporated in a reduced pressure of 0.1 Pa and the surface of the alignment layers 12 and 14 are exposed to the vapor of octadecanol. A board temperature is 150° C. hereupon.

The boards “A” and “B”, which are formed with the alignment layer respectively as mentioned above, are adhered by means of a spacer not shown so as to be a predetermined cell thickness and nematic liquid crystals 13 are injected between the boards “A” and “B”. Accordingly, an LCD element 10 is completed (refer to FIG. 1).

An excellent result is obtained by evaluating picture quality of the LCD element 10 manufactured as mentioned above through the same manner as for the embodiment one by using the optical system shown in FIG. 6.

By the method of forming an alignment layer of the LCD element 10 according to the embodiment three, a pre-tilt angle can be controlled to be within a range of 3 to 10 degrees that is excellent in repeatability. Therefore, displaying a video image in higher quality is enabled by a high resolution or micro pixel displaying element.

Heretofore, as disclosed in the Japanese Patent No. 2944226, a pre-tilt angle has been set to less than one degree. However, influence of disclination can hardly be disregarded in accordance with reducing pixel size. Consequently, it is found that disclination is improved by setting a pre-tilt angle to more than 3 degrees as disclosed in each embodiment of the present invention.

On the other hand, in a case that a pre-tilt angle is set to an angle exceeding 10 degrees, it is found that a contrast ratio decreases, as mentioned above, and resulting in generating problems in practical application.

According to the embodiment two of the present invention, in order to set a pre-tilt angle within a range of 3 to 10 degrees, an evaporation angle e is set to 40 to 60 degrees and a gas pressure is set to 6E-3 Pa to 3E-2 Pa. Consequently, a required pre-tilt angle of 3 to 10 degrees, which is excellent in repeatability, can easily be obtained.

Further, in the case of the embodiment three, the board temperature is set to 200° C. However, in a case that a board temperature is less than 150° C., it is observed that a pre-tilt angle changes with time.

Furthermore, in a case that the LCD element. 10 according to the embodiment one of the present invention is installed in a 3-plate system projector, a video image displaying system, which is high in light utilization ratio and excellent in cost per performance, and further which realizes higher resolution being excellent in reliability without being deteriorated by light, can be provided.

As mentioned above, according to the present invention, a pre-tilt angle of an alignment layer in an LCD element is set to an angle of 3 to 10-degrees that is relatively larger angle than a conventional pre-tilt angle. Accordingly, by producing or selecting an LCD element having a predetermined pre-tilt angle, a video image displaying system utilizing such an LCD element can reduce influence of disclination as well as ensuring picture contrast sufficiently.

Further, according to the present invention, an LCD element composed of an alignment layer having a pre-tilt angle of 3 to 10 degrees can be formed by using an inorganic material for alignment layer.

It will be apparent to those skilled in the art that various modifications and variations could be made in the reflective liquid crystal projection apparatus in the present invention without departing from the scope or spirit of the invention.

What is claimed is:

1. A liquid crystal display element comprising:
a pair of bases of which one base is a transparent base transmitting light;
liquid crystals having negative dielectric anisotropy sealed between the pair of bases; and
an inorganic alignment layer formed on each surface of the pair of bases facing toward the liquid crystals, the alignment layer orientating a pre-tilt angle of the liquid crystals toward an angle of 3 to 10 degrees.

2. A method of forming an alignment layer of a liquid crystal display element comprising:
a pair of bases of which one base is a transparent base transmitting light;
liquid crystals having negative dielectric anisotropy sealed between the pair of bases; and
an inorganic alignment layer formed on each surface of the pair of bases facing toward the liquid crystals, the alignment layer orientating a pre-tilt angle of the liquid crystals toward an angle of 3 to 10 degrees,
the method is further characterized in that
each of the pair of bases is displaced in a filming apparatus such that vapor stream of a material for the inorganic alignment layer displaced in the filming apparatus enters into each of the pair of bases at an angle of 40 to 60 degrees with respect to each normal line of the pair of bases,
a gas pressure of either oxygen gas or inert gas introduced into the filming apparatus is controlled so as to conduct the pre-tilt angle to be an angle of 3 to 10 degrees, and that the inorganic alignment layer is formed by being evaporated on each surface of the pair of bases.
